(19) United States
(12) Patent Application Publication
(10) Pub. No.: US 2015/0130832 A1
(43) Pub. Date: May 14, 2015

(54) METHOD, SYSTEM AND MOBILE TERMINAL FOR MOBILE TERMINAL-BASED IMAGE DISPLAY

(71) Applicant: TENCENT TECHNOLOGY (SHENZHEN) COMPANY LIMITED, Shenzhen Guangdong (CN)

(72) Inventor: Bin Zhou, Shenzhen Guangdong (CN)

(21) Appl. No.: 14/398,703

(22) PCT Filed: May 7, 2013
(86) PCT No.: PCT/CN2013/075253

§ 371 Date: Nov. 3, 2014

(30) Foreign Application Priority Data
May 7, 2012 (CN) 201210139021.2

(51) Int. Cl. G06F 3/0346; G06T 11/60; G06F 3/0484

(52) U.S. Cl. CPC G06F 3/0346; G06F 3/04845; G06T 11/60
USPC 345/629; 345/156

(57) ABSTRACT

A mobile terminal-based image display method, system, and a mobile terminal are described. The method may include acquiring, by a mobile terminal, a material image and fusing a background image and the material image. The mobile terminal may display the fused images together. Further, the mobile terminal may monitor a shake state, and, based on the shake state, control a movement of the material image against the background image. Application of embodiments of the method, system and mobile terminal may effectively improve image interaction success rates, and increase eCPM values.

### CROSS-REFERENCE TO RELATED APPLICATIONS

This application claims priority to Chinese Patent Application No. 201210139021.2, filed on May 7, 2012, entitled “METHOD, SYSTEM AND MOBILE TERMINAL for MOBILE TERMINAL-BASED IMAGE DISPLAY”, which is incorporated herein by reference in its entirety.

### FIELD OF TECHNOLOGY

The present invention relates to the field of image display technologies, and in particular, to a method, a system, and a mobile terminal for mobile terminal-based image display.

### BACKGROUND

With the rapid development of computer technologies and network technologies, Internet and instant messaging technologies play an important role in people's life, study, and work. Moreover, with the development of mobile devices, Internet evolves towards mobility.

The society has entered a highly developed information era. Also, competition between enterprises has transformed from the previous monotonous competition centering on product functions and quality to a complex competition with an enterprise's image, goods, and brand as important means and such competition has become major trends. This transformation is inseparable from the rapid development of modern image display industry.

In traditional image display activities, such basic elements as image owner, image contents, an image content recipient, and image presentation may reflect a degree of civilization of each era within a specific area. For example, the image display activities may reflect events in history or events related to a particular geographic area. All these image elements, as a kind of culture, may embody an imprint of times in courses of social and economic activities to different extents.

For example current methods for mobile terminal-based image display, an image provider may directly provide image materials and actively display images on the network. However, such methods may provide interaction techniques which do not take personal interests of image recipients into account and hence, lack effective interactions. Therefore, interaction success rate may be low.

### SUMMARY

Embodiments of the present invention may provide a method for mobile terminal-based image display to improve the interaction success rate.

Embodiments of the present invention may also provide a system for mobile terminal-based image display to improve the interaction success rate.

Embodiments of the present invention may further provide a mobile terminal to improve the interaction success rate.

In one aspect, a method for mobile terminal-based image display is provided. The method may include acquiring, by a mobile terminal, a material image. Further, the method may involve fusing and displaying, by the mobile terminal, a background image and the material image. Further, the method may monitor a shake state of the mobile terminal, and control, based on the shake state, a movement of the material image against the background image.

In another aspect, a system for mobile terminal-based image display is provided. The system may include a mobile terminal and a server, where the server may store a material image and send a background image and the material image to the mobile terminal. The mobile terminal may fuse and display the background image and the material image. The mobile terminal may further monitor its own shake state, and control, based on the shake state, a movement of the material image against the background image.

In another aspect a mobile terminal is provided. The mobile terminal may include a material image acquiring unit, a browser unit, and an image moving unit. The material image acquiring unit may acquire a material image. The browser unit may open a browser window, and fuse and display a background image and the material image in the browser window. The image moving unit may monitor the shake state of the mobile terminal, and control, based on the shake state, a movement of the material image against the background image.

As seen from the above technical solutions, the mobile terminal may first acquire a material image, and fuse and display a background image and the material image. The mobile terminal may also monitor the shake state of the mobile terminal, and control, based on the shake state of the mobile terminal, a movement of the material image against the background image. Therefore, after embodiments described are applied, the mobile terminal may no longer directly, or immediately, display the material image to users. Instead, the mobile terminal may fuse and display the material image and the background image together. The mobile terminal may control movements of the material image based on the shake state of the mobile terminal, so that users can control the movement of the material image against the background image by shaking the mobile terminal Therefore, described embodiments may implement image display extensively interactive with users. Thus, the image interaction success rate may be improved by increasing the effective cost per mille (eCPM) value, and further enhancing the image advertisement effect.

### BRIEF DESCRIPTION OF THE DRAWINGS

FIG. 1 is a flowchart of a method for mobile terminal-based image display according to an embodiment;

FIG. 2 is a schematic diagram of a material image of a car according to an embodiment;

FIG. 3 is a schematic diagram of simultaneously displaying a material image of a car and a background image according to an embodiment;

FIG. 4 is a schematic diagram of shake analysis of a mobile terminal according to an embodiment;

FIG. 5 is a structural diagram of a system for mobile terminal-based image display according to an embodiment; and

FIG. 6 is a schematic structural diagram of a mobile terminal according to an embodiment.

### DETAILED DESCRIPTION

To make the objectives, technical solutions, and advantages of embodiments of the present invention more comprehensible, the following embodiments are described in detail with reference to the accompanying drawings.

FIG. 1 is a flowchart of a method for mobile terminal-based image display according to an embodiment of the present invention.

As shown in FIG. 1, the method may include at least the following steps.

In Step 101 a mobile terminal may acquire a material image.

The mobile terminal may acquire material images from a network-side server in various download ways. The image recipient, image provider, or any third party may upload material images by various information transmission means, and save the images to the network-side server. The mobile terminal may acquire the material images from the server.

The material image may be an image, or a picture. The specific contents of the material images may be related to the materials expected to be displayed to users. For example, if information of a car brand is expected to be pushed, an image of a car model of the brand may be uploaded; if information of an electronic product is expected to be pushed, an image of the electronic product model may be uploaded.

The mobile terminal may also acquire the material images by taking photos with a local image pickup unit (for example, a camera), so that users may provide the material images by themselves.

There may be different types of background images and material images. A background image may be an image, or a picture, that is used as a background with the material image placed in the foreground. For example, background images and material images may be in any of the following formats: bitmap; joint photographic experts group (JPEG); tagged image file format (TIFF); graphics interchange format (GIF); portable network graphics (PNG); or three-dimensional image, and so on.

Data of a GIF image file may be compressed using a compression algorithm such as variable length compression. The GIF format may have another feature: Multiple color images may be saved in one GIF file. If data of the multiple images saved in one file are read out and displayed on the screen one by one, a simple animation may be formed. In an embodiment, the material image, such as the GIF type may be overlaid onto the background image for substantially simultaneous display.

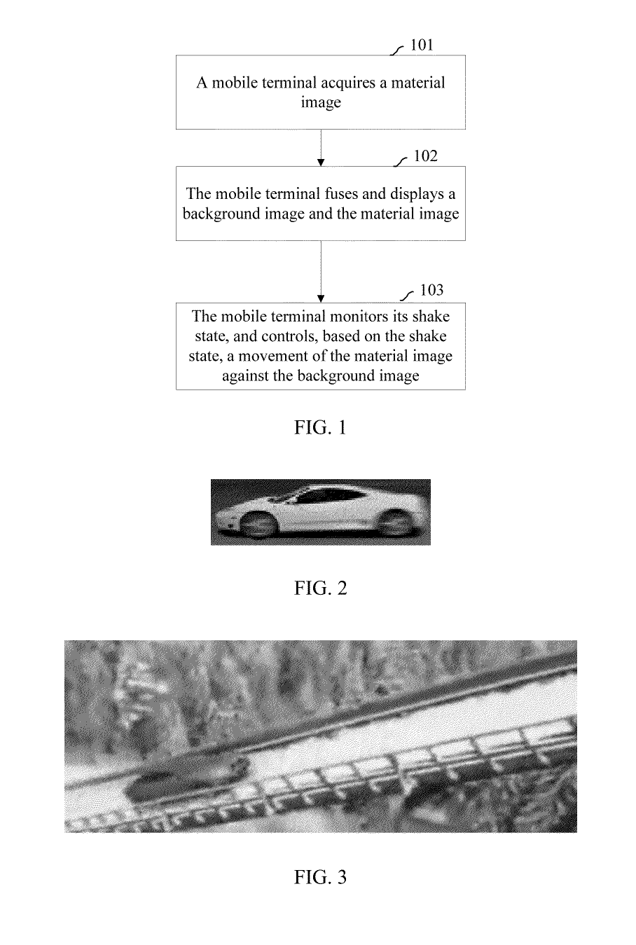

FIG. 2 is a schematic diagram of a material image of a car according to an embodiment.

Recipients of the pushed information, the image provider, or any third party may upload material images in different ways. For example, the image recipient may directly upload the material image using wireless Internet access. The image provider may upload material images to the server using a personal computer (PC).

In Step 102 the mobile terminal may fuse and display a background image and the material image together.

The server may provide background images for the mobile terminal Alternatively, or in addition, the mobile terminal may store background images locally in advance. Further, the mobile terminal may acquire background images by taking photos. The background images may be stored on the server because the server may have a larger storage space compared to the mobile terminal Therefore, large background images may be stored on the server. A few example background images may include blue sky, white cloud, great bridge, and road. Background images may include any other image.

In an embodiment, in addition to uploading the material images, the image recipient, image provider, or any third party may upload image attribute information that may be used to describe the type of the material images. Image attribute information may be text information. The type of the material image may also be described directly by the name thereof The server or the mobile terminal may determine the material image type according to the image attribute information. The server or the mobile terminal may search a background image that matches the material image. When the server provides background images, the server may provide a matched background image for the mobile terminal In this way, the mobile terminal may acquire the background image matching the material image. Here, matching the background image and the material image represents a pair of images that are suitably associated, or go well with each other, or have a connection or relationship between each other. Thus, the background image may be a counterpart of the material image. For example, the material image may fit together with the background image, or be analogous to the background image.

For example, if the material image is related to pushed information of a car, the server may search a background image that fits the context of cars (for example, a runway, bridge or a road). Instead, if the material image is related to pushed information of an electronic product, the server may search a background image that fits electronic products (for example, an office desk).

In case the server provides background images, the server may first send the uploaded material images and locally stored background images to the mobile terminal. The server may also send order information and/or advertisement information, to the mobile terminal to display.

After acquiring the material image and the background image, the mobile terminal may substantially simultaneously display the background image and the material image, thereby implementing a fusion display. The material image may be displayed over or in front of the background image.

FIG. 3 is a schematic diagram of simultaneous display of a material image of a car and a background image according to an embodiment.

As shown in FIG. 3, the material image is a car model and the background image is a bridge. The car model and the bridge are shown to be fused and displayed together, and moreover, the car stands on the bridge.

The mobile terminal may acquire the background image and the material image through a common gateway interface (CGI), and fuse and display the background image and material image in a browser window of the mobile terminal

The mobile terminal browser may be a browser running on a mobile terminal The mobile terminal may connect to the Internet in different ways such as general packet radio service (GPRS) technology, 4G, 3G, EDGE or any other technology, so as to browse internet content. Mobile terminal browsers may be supported by JAVA or smart phone systems (such as Apple's IOS and Android platform).

In Step 103 the mobile terminal may monitor its shake state, and based on the shake state, control a movement of the material image against the background image.

The background image and the material image may be displayed at a specific display position of the mobile terminal The shake state of the mobile terminal may be monitored. JavaScript code may be used to control movements of the material image at this display position.

For example, according to the development trends, the mobile terminal browsers may be directly embedded with support for mobile terminal motions. The accelerationIncludingGravity.x, accelerationIncludingGravity.y, and accelerationIncludingGravity.z displacement values of mobile terminals such as mobile phones may be acquired by monitoring events, such as a devicemotion event of mobile terminal browsers. The displacement values may be transmitted to a flash object or JavaScript code of the mobile terminal browser page. The time value may also be transmitted, for flash to judge the current speed. To dynamically coordinate the background material and the moving image material, a motion control container may be constructed to load a background material and one or more moving image materials. Triggered by a JavaScript event, simulated real motions of an object in the flash object may be smoothly processed.

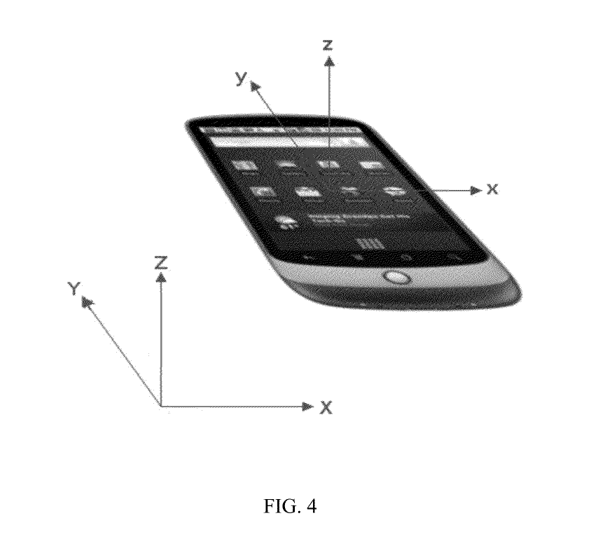

FIG. 4 is a schematic diagram of shake analysis of a mobile terminal according to an embodiment of the present invention.

First, an event, such as a devicemotion event of the browser window of the mobile terminal may be monitored, so as to monitor the shake state of the mobile terminal. An accelerationIncludingGravity value of the mobile terminal may be acquired from an event trigger function, such as a devicemotion event trigger function. The accelerationIncludingGravity value may include the accelerationIncludingGravity.x value. Movement of the material image against the background image may be controlled based on the displacement value in a particular orientation, such as accelerationIncludingGravity.x value.

In one example, if the accelerationIncludingGravity.x value is greater than 0, the material image may be controlled to move in a positive direction, such as right, against the background image. if the accelerationIncludingGravity.x value is smaller than 0, the material image may be controlled to move in a negative direction, such as left, against the background image; and/or when the accelerationIncludingGravity.x value is equal to 0, the material image may stay still against the background image. Thus, the material image may move in relation to the background image.

Therefore, if a user shakes the mobile terminal, the material image may move according to the shake state direction. For example, assume that the material image is a car model and the background image is a bridge. When the mobile terminal is swayed to incline to a certain direction, the car model in the image may move accordingly. The climbing height of the car model may be controlled by the inclination and force, thereby controlling the car model to climb or slide.

An example implementation of an example as JS code on a HTML page is shown below:

<script>

var flashObj = document.getElementById(“flash_id”); //Acquire a flash object.
window.addEventListener(“devicemotion”, callback, false); //Bind a devicemotion

event. The callback function is callback.

```
  function callback(e) {
  flashObj.setXYZ(e.accelerationIncludingGravity.x,e.accelerationIncludingGravity.
```

y,e.accelerationIncludingGravity.z,(new Date).getTime( )); //Transmit the x, y, and z
parameters and time parameter to the flash object, for flash to control object motions.

}

</script>

Processing of AS Code in Flash:

public function setXYZ(x,y,z,t) {
MOVE_ELEMENT.x = MOVE_ELEMENT.x + x; //Dynamically

set the physical coordinates of the object needed to move according to
the transmitted x value to simulate object motions.

Thus, based on the shake-state analysis, a system for mobile terminal-based image display may be provided.

FIG. 5 is a structural diagram of a system for mobile terminal-based image display according to an embodiment of the present invention.

As shown in FIG. 5, the system may include a mobile terminal 501 and a server 502.

The server 502 may be store a material image and send a background image and the material image to the mobile terminal 501.

The image recipient, image provider, or any third party may upload and store a material image to the server 502 using various information transmission manners. The specific content of material images may relate to a context of the material to be displayed. For example, if information of a car brand is expected to be pushed to the mobile terminal, an image of a model of the brand car may be uploaded. If information of an electronic product is expected to be pushed, an image of the electronic product model may be uploaded, and so on.

The mobile terminal 501 may fuse and display the background image and the material image. The mobile terminal 501 may monitor a shake state, and control, based on the shake state, a movement of the material image against the background image.

The mobile terminal 501 may refer to a computer device that may be moved, for example, a mobile phone, a notebook computer, a tablet, a personal digital assistant (PDA), a POS terminal, or even a vehicle mount computer.

The mobile terminal 501 may have multiple application functions.

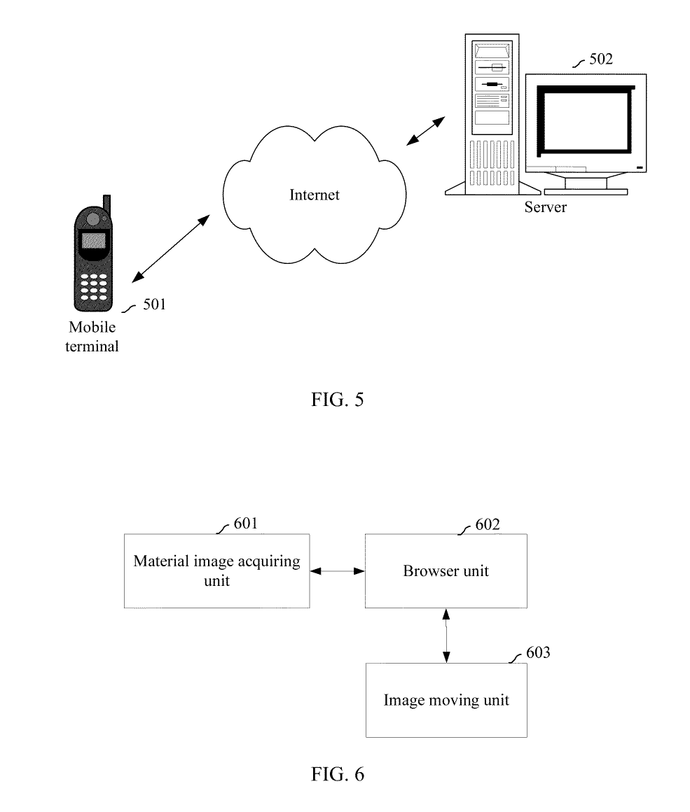

FIG. 6 is a schematic structural diagram of a mobile terminal according to an embodiment of the present invention.

As shown in FIG. 6, the mobile terminal may include a material image acquiring unit 601, a browser unit 602, and an image moving unit 603.

The material image acquiring unit 601 may acquire a material image. The material image acquiring unit 601 may acquire various material images by downloading from a remote network in various ways. Alternatively, or in addition, the material image acquiring unit 601 may acquire a material image by taking a photo by using a local image pickup unit (such as a camera).

The browser unit 602 may open a browser window, and fuse and display a background image and the material image in the browser window. The material image may be displayed over the background image.

Similarly, the background image may be acquired by downloading from a remote network in various ways or by taking a photo by using a local image pickup unit (such as a camera).

The image moving unit 603 may monitor the shake state of the mobile terminal, and control, based on the shake state, a movement of the material image against the background image.

In one embodiment, the browser unit 602 may acquire the background image and the material image from the server 502 through a common gateway interface (CGI), and fuse and display the background image and the material image in a browser window of the mobile terminal The material image may be displayed over the background image.

The image moving unit 603 may monitor a devicemotion event of the browser window of the mobile terminal, to monitor the shake state of the mobile terminal The image moving unit 603 may acquire an accelerationIncludingGravity value of the mobile terminal from a devicemotion event trigger function.; and control, based on the accelerationIncludingGravity value, a movement of the material image against the background image.

In one embodiment, the image moving unit 603 may control, according to the accelerationIncludingGravity.x value, a movement of the material image against the background image.

For example, when the accelerationIncludingGravity.x value is greater than 0, the image moving unit 603 may control the material image to move right against the background image;

when the accelerationIncludingGravity.x value is smaller than 0, the image moving unit 603 may control the material image to move left against the background image; or

when the accelerationIncludingGravity.x value is equal to 0, the image moving unit 603 may control the material image to stay still against the background image.

Thus, the physical model in the image may be controlled to move with the movement of the mobile terminal by shaking the mobile terminal

The above embodiments describe fusing and displaying a background image and a material image on a mobile terminal The embodiments also describe monitor a shake state of the mobile terminal, and controlling, based on the shake state of the mobile terminal, a movement of the material image against the background image displaying the image material and the background image together. This way, the embodiments may effectively improve an image interaction success rate and may increase the eCPM value. In the embodiments, material images may be uploaded or photographed by users. Material images may no longer be solely provided by image providers; instead, users may provide image materials.

Furthermore, the embodiments may control movements of a material image according to the shake state of the mobile terminal, and further provide an image display method extensively interactive with users, thereby further enhancing an image advertisement effect. Although the above description refers to a material image and a background image, the images may be referred to using different phrases, such as, for example a first image and a second image, or a front image and a back image, respectively. The background image is part of a scene or picture that is farthest from the viewer, the scene being composed by placing the material image in the foreground in relation to the background image. For example, the background image may be the part of the scene representing what lies behind objects in the material image, which is in the foreground.

What is described above are only specific embodiments and is not intended to limit the present disclosure. Any change, equivalent substitution and improvement made within the spirit and principle of the present invention all fall within the scope of protection of the present disclosure. The foregoing detailed description has described only a few of the many possible implementations of the present disclosure. For this reason, this description of example embodiments is intended by way of illustration, and not by way of limitation. The methods, devices, and logic described above may be implemented in many different ways in many different combinations of hardware, software or both hardware and software.

1. A method for mobile terminal-based image display, comprising:
acquiring, by a mobile terminal, a material image;
fusing and displaying, by the mobile terminal, the material image and a background image; and
monitoring, by the mobile terminal, a shake state of the mobile terminal, and controlling, based on the shake state, a movement of the material image against the background image.

2. The method for mobile terminal-based image display according to claim 1, wherein before fusing and displaying, by the mobile terminal, the material image and the background image, the method further comprises:
acquiring, by the mobile terminal, the background image matching the material image.

3. The method for mobile terminal-based image display according to claim 1, wherein the fusing and displaying, by the mobile terminal, the background image and the material image comprises:
acquiring, by the mobile terminal, the background image and the material image through a common gateway interface (CGI), and fusing and displaying the background image and the material image in a browser window of the mobile terminal.

4. The method for mobile terminal-based image display according to claim 1, wherein the monitoring, by the mobile terminal, the shake state, and the controlling, based on the shake state, a movement of the material image against the background image comprises:
monitoring a device_motion event of a browser window of the mobile terminal, to monitor the shake state of the mobile terminal;
acquiring an accelerationIncludingGravity value of the mobile terminal from an event trigger function; and
controlling, according to the accelerationIncludingGravity value, the movement of the material image against the background image.

5. The method for mobile terminal-based image display according to claim 4, wherein the controlling, according to the accelerationIncludingGravity value, the movement of the material image against the background image comprises:
acquiring an accelerationIncludingGravity.x value; and
controlling the material image to move right against the background image when the accelerationIncludingGravity.x value is greater than 0; or
controlling the material image to move left against the background image when the accelerationIncludingGravity.x value is smaller than 0; or
controlling the material image to stay still against the background image when the accelerationIncludingGravity.x value is equal to 0.

6. The method for mobile terminal-based image display according to claim 1, wherein a material image type is one of the following formats:
bitmap;
joint photographic experts group (JPEG);
tagged image file format (TIFF);
graphics interchange format (GIF);
portable network graphics (PNG); or
three-dimensional image.

7. The method for mobile terminal-based image display according to claim 1, wherein a background image type is one of the following formats:
bitmap;
joint photographic experts group (JPEG);
tagged image file format (TIFF);
graphics interchange format (GIF);
portable network graphics (PNG); or
three-dimensional image.

8. The method for mobile terminal-based image display according to claim 2, wherein before acquiring, by the mobile terminal the background image matching the material image, the method further comprises:
searching, by a server or the mobile terminal according to the material image, the background image matching the material image.

9. A system for mobile terminal-based image display, comprising a mobile terminal and a server, wherein:
the server is configured to store a material image and further configured to send a background image and the material image to the mobile terminal;
the mobile terminal is configured to fuse and display the background image and the material image; and
the mobile terminal is further configured to monitor a shake state, and control, based on the shake state, a movement of the material image against the background image.

10. The system for mobile terminal-based image display according to claim 9, wherein the mobile terminal comprises a browser unit and an image moving unit, wherein:
the browser unit is configured to open a browser window, and fuse and display the background image and the material image in the browser window; and
the image moving unit is configured to monitor the shake state of the mobile terminal, and control, based on the shake state, the movement of the material image against the background image.

11. The system for mobile terminal-based image display according to claim 10, wherein:
the browser unit is configured to acquire the background image and the material image from the server through a common gateway interface (CGI), wherein the material image is displayed over the background image.

12. The system for mobile terminal-based image display according to claim 10, wherein:
the image moving unit is configured to monitor an event of the browser window of the mobile terminal, to monitor the shake state of the mobile terminal;
the image moving unit is further configured to acquire a displacement value indicating amount of displacement of the mobile terminal; and
the image moving unit is further configured to control, according to the displacement value, the movement of the material image against the background image.

13. The system for mobile terminal-based image display according to claim 12, wherein:
the image moving unit is configured to acquire the displacement value wherein the displacement further indicates amount of displacement of the mobile terminal in a particular orientation; and
the image moving unit is further configured to:
control the material image to move in a positive direction along the particular orientation against the background image when the displacement value is greater than 0;
control the material image to move in a negative direction along the particular orientation against the background image when the displacement value is smaller than 0; or
control the material image to stay still against the background image when the displacement value is equal to 0.

14. A mobile terminal, comprising a material image acquiring unit, a browser unit, and an image moving unit, wherein:
the material image acquiring unit is configured to acquire a material image;
the browser unit is configured to open a browser window, and fuse and display a background image and the material image in the browser window; and
the image moving unit is configured to monitor a shake state of the mobile terminal, and further configured to control, based on the shake state, a movement of the material image against the background image.

15. The mobile terminal according to claim 14, wherein the material image acquiring unit is configured to acquire the background image and the material image from a server through a common gateway interface (CGI).

16. The mobile terminal according to claim 14, wherein the image moving unit is configured to:
monitor a motion event of the browser window of the mobile terminal, to monitor the shake state of the mobile terminal;
acquire displacement value of the mobile terminal from in response to the motion event; and
control, based on the displacement value, the movement of the material image against the background image.
